(19) United States
(12) Patent Application Publication
(10) Pub. No.: US 2020/0249534 A1
(43) Pub. Date: Aug. 6, 2020

(54) ARRAY SUBSTRATE, LIQUID CRYSTAL DISPLAY PANEL AND LIQUID CRYSTAL DISPLAY APPARATUS

(71) Applicants: BOE TECHNOLOGY GROUP CO., LTD., Beijing (CN); BEIJING BOE DISPLAY TECHNOLOGY CO., LTD., Beijing (CN)

(72) Inventors: Fangyu Wang, Beijing (CN); Xibin Shao, Beijing (CN); Zhenyu Zhang, Beijing (CN); Dongchuan Chen, Beijing (CN); Xueqiang Qian, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/761,347

(22) PCT Filed: Apr. 1, 2017
(86) PCT No.: PCT/CN2017/079339

§ 371 Date: Mar. 19, 2018

(51) Int. Cl. G02F 1/1343

(52) U.S. Cl. CPC G02F 1/134309; G02F 2201/123; G02F 2201/121; G02F 2001/134372

(57) ABSTRACT

The present application discloses an array substrate having a plurality of subpixel areas, the array substrate in each of the plurality of subpixel areas includes a first electrode layer and a second electrode layer configured to form a fringe field for driving liquid crystal molecules; and an insulating layer between the first electrode layer and the second electrode layer. The second electrode layer includes a plurality of branches; the plurality of branches being grouped into a plurality of teeth; adjacent teeth of the plurality of teeth being spaced apart by a first slit, the first slit extending substantially throughout one dimension of the second electrode layer of one of the plurality of subpixel areas; and the adjacent teeth separated from each other at a first end and connected to each other at a second end.

### TECHNICAL FIELD

The present invention relates to display technology, more particularly, to an array substrate, a liquid crystal display panel and a liquid crystal display panel apparatus.

### BACKGROUND

In a fringe field driven liquid crystal display panel, the liquid crystal layer is driven by a fringe electric field. Examples of fringe field driven liquid crystal display panel include an advanced super-dimensional switching (ADS) liquid crystal display panel. For example, in the ADS liquid crystal display panel, a multi-dimensional electrical field is formed by an electric field generated by edges of slit electrodes in a same plane, and an electric field generated by a slit electrode layer and a plate electrode layer. The liquid crystal molecules between the slit electrodes and above the slit electrodes are rotated by the above-mentioned electrode fields. The operation efficiency and the light transmittance efficiency of the liquid crystal display panel are greatly improved in the ADS liquid crystal display panel.

### SUMMARY

In one aspect, the present invention provides au array substrate having a plurality of subpixel areas, the array substrate in each of the plurality of subpixel areas comprising a first electrode layer and a second electrode layer configured to form a fringe field for driving liquid crystal molecules; and an insulating layer between the first electrode layer and the second electrode layer; wherein the second electrode layer comprises a plurality of branches; the plurality of branches are grouped into a plurality of teeth; adjacent teeth of the plurality of teeth are spaced apart by a first slit, the first slit extending substantially throughout one dimension of the second electrode layer of one of the plurality of subpixel areas; and the adjacent teeth separated from each other at a first end and connected to each other at a second end.

Optionally, each of the plurality of teeth comprises only one of the plurality of branches.

Optionally, the second electrode layer is a comb-shaped electrode layer further comprising a bar connecting the adjacent teeth of the plurality of teeth at the second end.

Optionally, the bar is in a peripheral region of the second electrode layer.

Optionally, the array substrate further comprises a common electrode signal line; wherein a projection of the common electrode signal line on the array substrate at least partially overlaps with that of the bar.

Optionally, the projection of the common electrode signal line on the array substrate substantially overlaps with that of the bar.

Optionally, the projection of the common electrode signal line on the array substrate completely covers that of the bar.

Optionally, the array substrate further comprises a common electrode signal line; wherein a projection of the common electrode signal line on the array substrate at least partially overlaps with those of the plurality of teeth at the first end.

Optionally, each of the plurality of teeth comprises a first branch and a second branch of the plurality of branches; and the first branch and the second branch are spaced apart by a second slit, the second slit extending substantially throughout the one dimension of the second electrode layer.

Optionally, the second slit is substantially parallel to the first slit; the first branch and the second branch are connected to each other at a third end and separated from each other at a fourth end; the third end is proximal to the first end and distal to the second end; and the fourth end is proximal to the second end and distal to the first end.

Optionally, the second electrode layer is a zig-zag shaped electrode layer.

Optionally, the first electrode layer is a plate electrode layer extending substantially throughout one of the plurality of subpixel areas.

Optionally, each of the plurality of branches extends substantially throughout the one dimension of the second electrode layer.

Optionally, any structure connecting the adjacent teeth is in peripheral regions of the second electrode layer.

Optionally, the first end and the second end are in peripheral regions of the second electrode layer.

Optionally, the second electrode layer comprises a first domain and a second domain, branches and slits in the first domain extending substantially along a first direction, and branches and slits in the second domain extending substantially along a second direction.

Optionally, the plurality of branches extend substantially along a longitudinal direction of the subpixel area.

Optionally, the plurality of branches extend substantially along a lateral direction of the subpixel area.

Optionally, the first electrode layer is a common electrode layer, and the second electrode layer is a pixel electrode layer.

Optionally, the second electrode layer is a common electrode layer, and the first electrode layer is a pixel electrode layer.

In another aspect, the present invention provides a liquid crystal display panel comprising the array substrate described herein.

Optionally, the liquid crystal display panel is a fringe field driven liquid crystal display panel, in which liquid crystal molecules in the liquid crystal layer is driven by a fringe electric field.

Optionally, the liquid crystal display panel is an advance super-dimensional switch (ADS) type liquid crystal display panel.

In another aspect, the present invention provides a liquid crystal display apparatus comprising a liquid crystal display panel described herein.

### BRIEF DESCRIPTION OF THE FIGURES

The following drawings are merely examples for illustrative purposes according to various disclosed embodiments and are not intended to limit the scope of the present invention.

FIG. 1 is a schematic diagram illustrating the structure of a conventional liquid crystal display panel.

FIG. 2 is a cross-sectional view along A-A′ line of the liquid crystal display panel in FIG. 1.

FIG. 3 is a schematic diagram illustrating the structure of a liquid crystal display panel in some embodiments according to the present disclosure.

FIG. 4 is a cross-sectional view along B-B′ line of the liquid crystal display panel in FIG. 3.

FIG. 5 is a schematic diagram illustrating the structure of a liquid crystal display panel in some embodiments according to the present disclosure.

FIG. 6 is a schematic diagram illustrating the structure of a liquid crystal display panel in some embodiments according to the present disclosure.

FIG. 7 is a cross-sectional view along C-C′ line of the liquid crystal display panel in FIG. 6.

FIG. 8 is a cross-sectional view along D-D′ line of the liquid crystal display panel in FIG. 6.

FIG. 9 is a schematic diagram illustrating the structure of a conventional liquid crystal display panel.

FIG. 10 is a schematic diagram illustrating the structure of a liquid crystal display panel in some embodiments according to the present disclosure.

FIG. 11 is a schematic diagram illustrating the structure of a liquid crystal display panel in some embodiments according to the present disclosure.

FIG. 12 is a schematic diagram illustrating the structure of a liquid crystal display panel in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

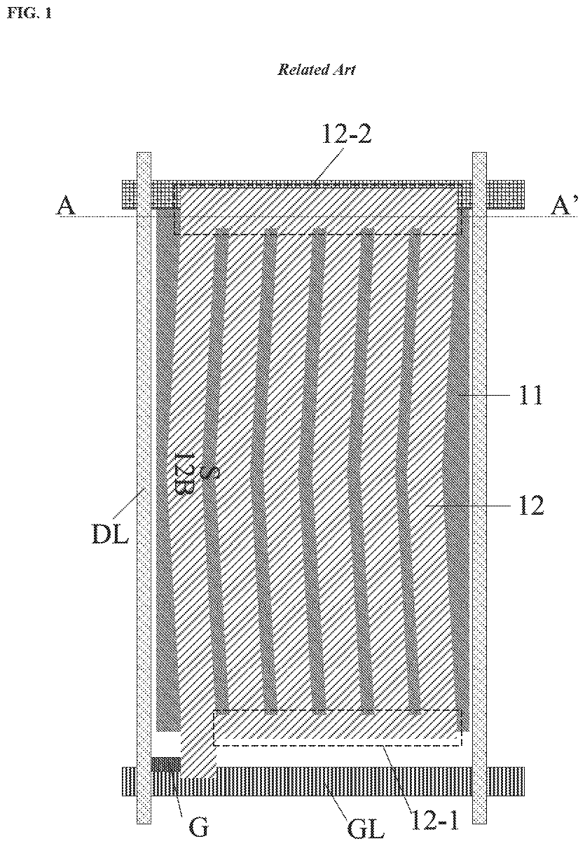

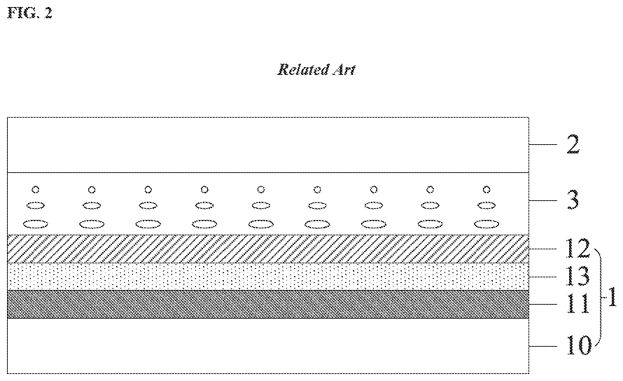

FIG. 1 is a schematic diagram illustrating the structure of a conventional liquid crystal display panel. FIG. 2 is a cross-sectional view along A-A′ line of the liquid crystal display panel in FIG. 1. Referring to FIGS. 1 and 2, the conventional liquid crystal display panel includes an array substrate 1, a counter substrate 2 facing the array substrate 1, and a liquid crystal layer 3 between the array substrate 1 and the counter substrate 2. The liquid crystal display panel includes a first electrode layer 11, a second electrode layer 12, and an insulating layer 13 between the first electrode layer 11 and the second electrode layer 12. The second electrode layer 12 may be, for example, a pixel electrode layer. As shown in FIG. 1, the pixel electrode layer includes a plurality of branches 12B spaced apart by a plurality of slits S. The plurality of branches 12B are connected together by a first bar 12-1 at the bottom of the second electrode layer 12 and a second bar 12-2 at the top of the second electrode layer 12. Each of the plurality of slits S has a first end and a second end, both of which are closed ends. For example, the first bar 12-1 and the second bar 12-2 close each of the plurality of slits S at its first end and the second end. The first electrode layer 11 extends to the edges of the subpixel area. Referring to FIG. 1, a projection of the first electrode layer 11 on a base substrate 10 overlaps with that of the first bar 12-1 of the second electrode layer 12 throughout the width of the first electrode layer 11 along the edge of the subpixel area. Due to the large overlapping areas between the first electrode layer 11 and the second electrode layer 12, e.g., in the regions corresponding to the first bar 12-1 and the second bar 12-2, a large storage capacitance forms between the first electrode layer 11 and the second electrode layer 12. The storage capacitance may be determined by the following equation:

$$C = ɛ \frac{s}{d} ;$$

wherein ϵ is the dielectric constant, S is the overlapping area of the first electrode layer 11 and the second electrode layer 12, and d is the distance between the first electrode layer 11 and the second electrode layer 12.

Typically, the first electrode layer 11 and the second electrode layer 12 are made of indium tin oxide or other similar metal oxide or transparent conductive materials. Along the edges of the subpixel area, light has to pass through two electrode layers, e.g., first passing through the first electrode layer 11, then passing through the first bar 12-1 or the second bar 12-2. Thus, light transmittance in the regions corresponding to the first bar 12-1 and the second bar 12-2 is reduced, e.g., by 20%, forming dark areas along the edges of the subpixel area.

Accordingly, the present disclosure provides, inter alia, an array substrate, a liquid crystal display panel and a liquid crystal display apparatus that substantially obviate one or more of the problems due to limitations and disadvantages of the related art. In one aspect, the present disclosure provides a liquid crystal display panel. In some embodiments, the liquid crystal display panel includes a liquid crystal display panel having an array substrate and a counter substrate facing the array substrate, and a plurality of subpixels. The liquid crystal display panel in each subpixel includes a liquid crystal layer between the array substrate and the counter substrate; a first electrode layer and a second electrode layer configured to form a fringe field for driving liquid crystal molecules in the liquid crystal layer; and an insulating layer between the first electrode layer and the second electrode layer; wherein the second electrode layer comprises a plurality of branches; the plurality of branches may be grouped into a plurality of teeth; adjacent teeth of the plurality of teeth are spaced apart by a first slit, the first slit being open at a first end E1 and closed at a second end E2, and extending substantially throughout one dimension of the second electrode layer, the first end E1 opposite to the second end E2; and the adjacent teeth separated from each other at the first end E1 and connected to each other at the second end E2. Optionally, the first electrode layer is a common electrode layer, and the second electrode layer is a pixel electrode layer. Optionally, the second electrode layer is a common electrode layer, and the first electrode layer is a pixel electrode layer. In the context of the present disclosure, each of the plurality of teeth may include one or more adjacent branches. Optionally, each of the plurality of teeth includes only one branch. Optionally, each of the plurality of teeth includes two adjacent branches. Optionally, each of the plurality of teeth includes more than two adjacent branches.

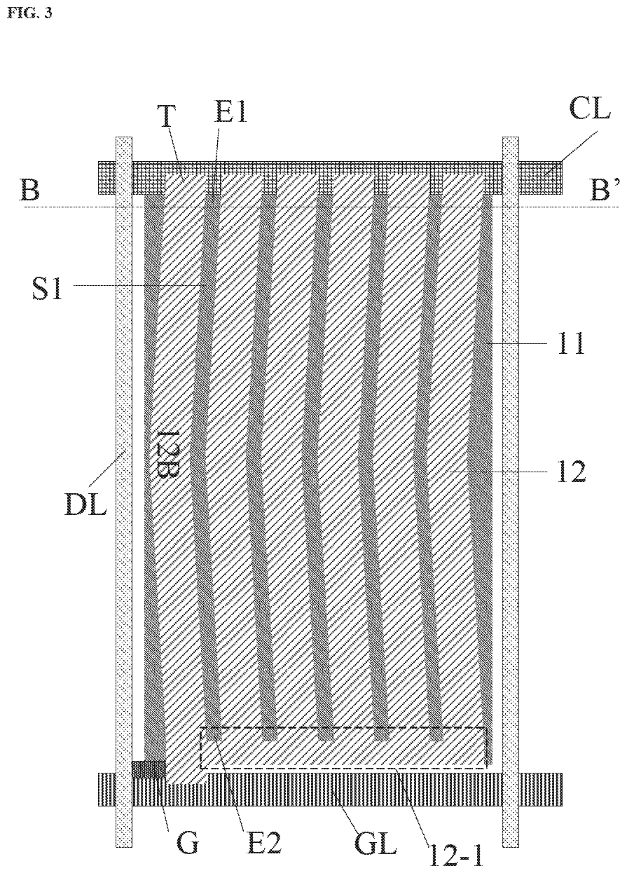

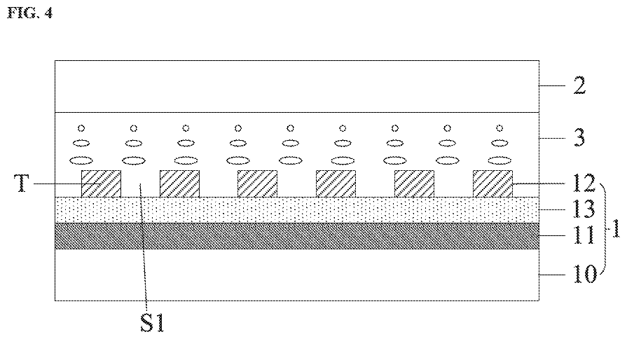

FIG. 3 is a schematic diagram illustrating the structure of a liquid crystal display panel in some embodiments according to the present disclosure. FIG. 4 is a cross-sectional view along B-B′ line of the liquid crystal display panel in FIG. 3. Referring to FIGS. 3 and 4, the liquid crystal display panel in some embodiments includes an array substrate 1, a counter substrate 2 facing the array substrate 1, and a liquid crystal layer 3 between the array substrate 1 and the counter substrate 2. The liquid crystal display panel includes a plurality of subpixels. In each subpixel, the liquid crystal display panel includes a first electrode layer 11, a second electrode layer 12, and an insulating layer 13 between the first electrode layer 11 and the second electrode layer 12. The first electrode layer 11 and the second electrode layer 12 are configured to form a fringe field for driving liquid crystal molecules in the liquid crystal layer 3. The liquid crystal display panel further includes a plurality of gate lines GL and a plurality of data lines DL crossing over each other thereby defining a plurality of subpixels. Each subpixel further includes a switching thin film transistor having a gate electrode G for driving image display in the subpixel. When the second electrode layer 12 is a pixel electrode layer (as shown in FIG. 3), the second electrode layer 12 is connected to a drain electrode of the switching thin film transistor, and one of the plurality of data lines DL is connected to a source electrode of the switching thin film transistor. Optionally, the second electrode layer 12 is a common electrode layer, the first electrode layer 11 is a pixel electrode layer, and the first electrode layer 11 is connected to the drain electrode of the switching thin film transistor.

As shown in FIG. 3, the first electrode layer 11 (e.g., a common electrode layer) is a plate electrode layer that extends substantially throughout the subpixel, e.g., extending to a first edge of the subpixel (e.g., proximal to the B-B′ line in FIG. 3). The second electrode layer 12 includes a plurality of branches 12B, each of which extends substantially along a longitudinal direction of the subpixel. Optionally, the plurality of branches 12B extend along a direction substantially parallel to the plurality of data lines DL. Optionally, the plurality of branches 12B extend along a direction substantially parallel to the plurality of gate lines GL. The plurality of branches 12B are spaced apart by a plurality of slits (e.g., a first slit S1 in FIG. 3).

In some embodiments, the plurality of branches 12B may be grouped into a plurality of teeth T. In the embodiment depicted in FIG. 3, each of the plurality of branches 12B corresponds to one of the plurality of teeth T, e.g., each of the plurality of teeth T includes only one of the plurality of branches 12B. Adjacent teeth of the plurality of teeth T are spaced apart by a first slit S1. Thus, in the embodiment depicted in FIG. 3, adjacent branches of the plurality of branches 12B are spaced apart by a first slit S1.

The first slit S1 is open at a first end E1 (e.g., the end proximal to a first signal line along a first edge of the subpixel), and closed at a second end E2 (e.g., the end proximal to a second signal line along a second edge of the subpixel, the second edge opposite to the first edge). The first end E1 is opposite to the second end E2. The first slit S1 extends along a direction substantially parallel to the adjacent teeth (or adjacent branches 12B in an embodiment depicted in FIG. 3), the first end E1 of the first slit S1 proximal to a first end of one of the plurality of branches 12B and distal to a second end of the one of the plurality of branches 12B opposite to the first end of the one of the plurality of branches 12B; and the second end E2 of the first slit S1 proximal to the second end of one of the plurality of branches 12B and distal to the first end of the one of the plurality of branches 12B. The first slit S1 extends substantially throughout one dimension of the second electrode layer 12, e.g., throughout the longitudinal dimension of the second electrode layer 12. Adjacent teeth are separated from each other at the first end E1 and connected to each other at the second end E2. In the embodiments depicted in FIG. 3, adjacent branches of the plurality of branches 12B are separated from each other at the first end E1 and connected to each other at the second end E2.

In the embodiment depicted in FIG. 3, the second electrode layer 12 is a comb-shaped electrode layer having a plurality of teeth T and a bar (e.g., a first bar 12-1 as shown in FIG. 3) connecting the adjacent teeth of the plurality of teeth T at the second end E2. As compared to conventional liquid crystal display panels, the liquid crystal display panel as shown in FIG. 3 only has one bar along only one edge of the subpixel, e.g., lacks a second bar along an opposite edge of the subpixel. Comparing the cross-sections illustrated in FIG. 2 and FIG. 4, the present design greatly reduces the overlapping area between the first electrode layer 11 and the second electrode layer 12. As a result, the storage capacitance between the first electrode layer 11 and the second electrode layer 12 is much reduced. As shown in FIG. 4, the present liquid crystal display panel includes multiple slits along the edge of the subpixel, in these areas, light need not pass through two electrode layers. Thus, light transmittance along the edges of the subpixels is significantly improved, obviating the issue of dark areas along the edges of the subpixels.

Referring to FIG. 3, each of the plurality of branches 12B extends substantially throughout one dimension (e.g., the longitudinal dimension) of the second electrode layer 12. Any structure connecting the adjacent teeth or adjacent branches is disposed in peripheral regions of the second electrode layer 12. The first end E1 and the second end E2 of the first slit S1 are in peripheral regions of the second electrode layer 12. The bar connecting the adjacent teeth of the plurality of teeth is also in a peripheral region of the second electrode layer 12.

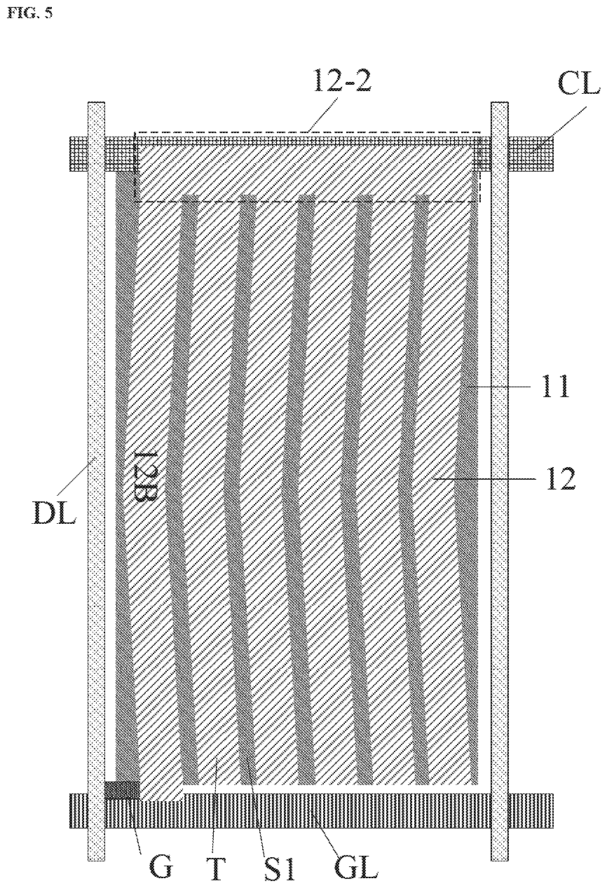

FIG. 5 is a schematic diagram illustrating the structure of a liquid crystal display panel in some embodiments according to the present disclosure. In the embodiment depicted in FIG. 3, the bar connecting the adjacent teeth or adjacent branches is a first bar 12-1 proximal to a gate line configured to provide a gate scanning signal to the subpixel for control light emission of the subpixel. In the embodiment depicted in FIG. 5, the bar connecting the adjacent teeth or adjacent branches is a second bar 12-2 along a first edge of the subpixel opposite to a second edge of the subpixel where the gate line controlling light emission of the subpixel is located. Similar to the embodiment depicted in FIG. 3, the overlapping area and storage capacitance between the first electrode layer 11 and the second electrode layer 12 are significantly reduced as compared to conventional liquid crystal display panels. Light transmittance along the edges of the subpixels is enhanced, eliminating dark edges in image display.

In some embodiments, the liquid crystal display panel further includes a plurality of common electrode signal lines. As shown in FIGS. 3 and 5, each subpixel is associated with a common electrode signal line CL. Optionally, the common electrode signal line CL is at a position proximal to the first edge of the subpixel opposite to a second edge of the subpixel where the gate line controlling light emission of the subpixel is located. Referring to FIG. 3, in some embodiments, a projection of the common electrode signal line CL on the array substrate at least partially overlaps with those of the plurality of teeth T at the first end E1.

Referring to FIG. 5, in some embodiments, a projection of the common electrode signal line CL on the array substrate at least partially overlaps with that of the second bar 12-2. Optionally, the projection of the common electrode signal line CL on the array substrate substantially overlaps with that of the second bar 12-2. Optionally, the projection of the common electrode signal line CL on the array substrate completely covers that of the second bar 12-2. The regions in the subpixel area corresponding to the common electrode signal line CL are dark regions. By disposing the bar at least partially in the regions corresponding to the common electrode signal line CL, the aperture ratio and light transmittance of the display panel are minimally affected or unaffected by the bar.

In some embodiments, and as shown in FIG. 3 and FIG. 5, the common electrode signal line CL is in a same layer as the plurality of gate line GL. Optionally, the common electrode signal line CL and the plurality of gate line GL are made of a same material and patterned using a same mask plate. In some embodiments, the common electrode signal line CL is in a layer different from that of the plurality of gate line GL.

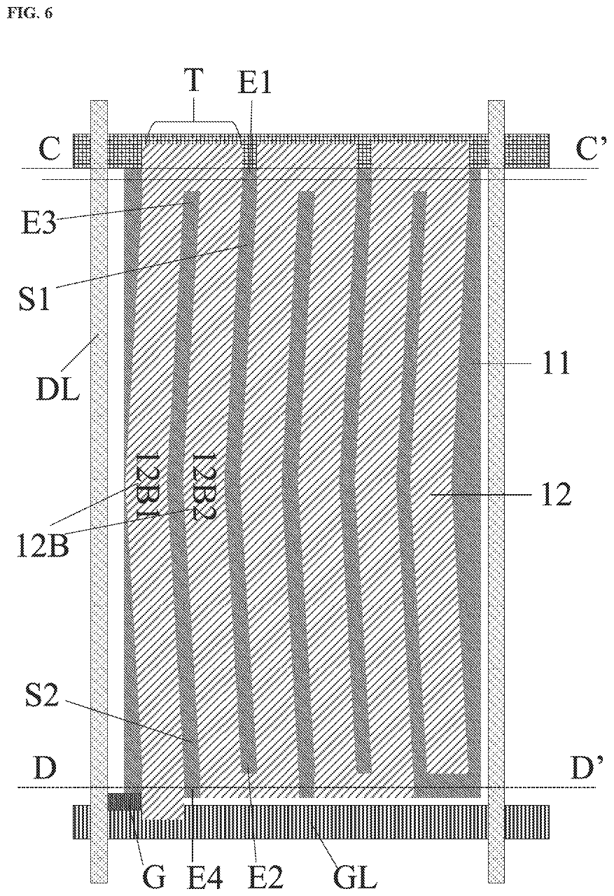

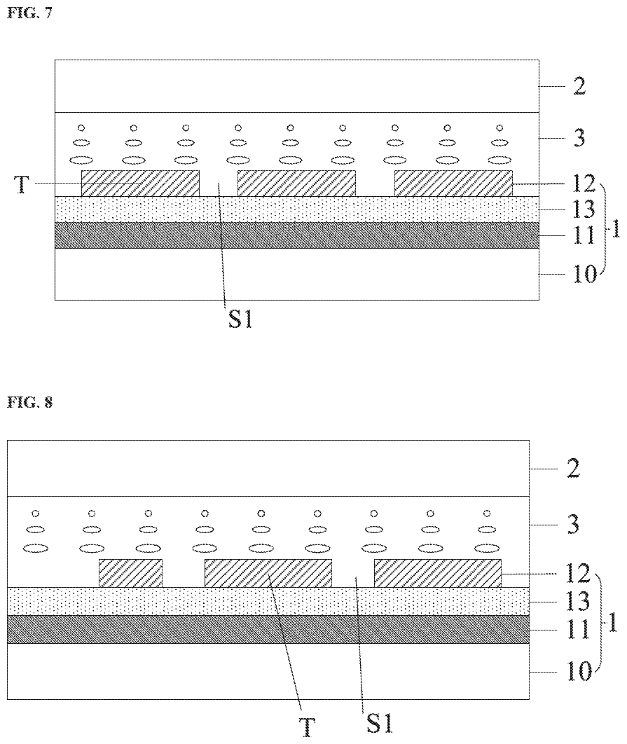

FIG. 6 is a schematic diagram illustrating the structure of a liquid crystal display panel in some embodiments according to the present disclosure. FIG. 7 is a cross-sectional view along C-C′ line of the liquid crystal display panel in FIG. 6. FIG. 8 is a cross-sectional view along D-D′ line of the liquid crystal display panel in FIG. 6. Referring to FIGS. 6 to 8, in each subpixel, the liquid crystal display panel in some embodiments includes a first electrode layer 11, a second electrode layer 12, and an insulating layer 13 between the first electrode layer 11 and the second electrode layer 12. The first electrode layer 11 and the second electrode layer 12 are configured to form a fringe field for driving liquid crystal molecules in the liquid crystal layer 3. Optionally, the second electrode layer 12 is a common electrode layer, the first electrode layer 11 is a pixel electrode layer, and the first electrode layer 11 is connected to the drain electrode of the switching thin film transistor.

As shown in FIG. 6, the first electrode layer 11 (e.g., a common electrode layer) is a plate electrode layer that extends substantially throughout the subpixel area, e.g., extending to a first edge of the subpixel (e.g., proximal to the C-C′ line in FIG. 6). The second electrode layer 12 includes a plurality of branches 12B (e.g., a first branch 12B1 and a second branch 12B2 in FIG. 6), each of which extends substantially along a longitudinal direction of the subpixel. The plurality of branches 12B are spaced apart by a plurality of slits (e.g., a first slit S1 and a second slit S2 in FIG. 6).

In some embodiments, the plurality of branches 12B may be grouped into a plurality of teeth T. In the embodiment depicted in FIG. 6, each of the plurality of teeth T includes a first branch 12B1 and a second branch 12B2 of the plurality of branches 12B. The first branch 12B1 and the second branch 12B2 are connected to each other along the first edge of the subpixel proximal to the C-C′ line in FIG. 6. Adjacent teeth of the plurality of teeth T are spaced apart by a first slit S1. The first branch 12B1 and the second branch 12B2 in each of the plurality of teeth T are spaced apart by a second slit S2.

The first slit S1 is open at a first end E1 (e.g., the end proximal to a first signal line along a first edge of the subpixel), and closed at a second end E2 (e.g., the end proximal to a second signal line along a second edge of the subpixel, the second edge opposite to the first edge). The first end E1 is opposite to the second end E2. The first slit S1 extends along a direction substantially parallel to the adjacent teeth (or adjacent branches 12B in an embodiment depicted in FIG. 6), the first end E1 of the first slit S1 proximal to a first end of one of the plurality of teeth T and distal to a second end of the one of the plurality of teeth T opposite to the first end of the one of the plurality of teeth T; and the second end E2 of the first slit S1 proximal to the second end of one of the plurality of teeth T and distal to the first end of the one of the plurality of teeth T. The first slit S 1 extends substantially throughout one dimension of the second electrode layer 12, e.g., throughout the longitudinal dimension of the second electrode layer 12. Adjacent teeth are separated from each other at the first end E1 and connected to each other at the second end E2.

The second slit S2 is closed at a third end E3 (e.g., the end proximal to a first signal line along a first edge of the subpixel) and open at a fourth end E4 (e.g., the end proximal to a second signal line along a second edge of the subpixel, the second edge opposite to the first edge). The third end E3 is opposite to the fourth end E4. The second slit S2 extends along a direction substantially parallel to the first branch 12B1 and the second branch 12B2 in each of the plurality of teeth T, the third end E3 of the second slit S2 proximal to a first end of one of the plurality of teeth T and distal to a second end of the one of the plurality of teeth T opposite to the first end of the one of the plurality of teeth T; and the fourth end E4 of the second slit S2 proximal to the second end of one of the plurality of teeth T and distal to the first end of the one of the plurality of teeth T. The second slit S2 extends substantially throughout the one dimension of the second electrode layer 12, e.g., throughout the longitudinal dimension of the second electrode layer 12.

In some embodiments, the second slit S2 is substantially parallel to the first slit S1. Optionally, the third end E3 is proximal to the first end E1 and distal to the second end E2, and the fourth end E4 is proximal to the second end E2 and distal to the first end E1. Optionally, the first branch 12B1 and the second branch 12B2 are separated from each other at the fourth end E4 and connected to each other at the third end E3.

In some embodiments, the second electrode layer 12 is a zig-zag shaped electrode layer. As shown in FIG. 6, along both the first edge and the second edge of the subpixel, the liquid crystal display panel includes a plurality of teeth T. As shown in FIGS. 7 and 8, the present liquid crystal display panel includes multiple slits along both edges of the subpixel. As compared to conventional liquid crystal display panels, the liquid crystal display panel depicted in the embodiment of FIGS. 6 to 8 has greatly reduced overlapping areas between the first electrode layer 11 and the second electrode layer 12. The storage capacitance between the first electrode layer 11 and the second electrode layer 12 is much reduced. In the multiple slits areas along both edges of the subpixel, light need not pass through two electrode layers. Thus, light transmittance along the edges of the subpixels is significantly improved, obviating the issue of dark areas along the edges of the subpixels.

In the embodiments depicted in FIGS. 3-7, the plurality of branches extend substantially along a longitudinal direction of the subpixel. Optionally, the plurality of branches extend substantially along a lateral direction of the subpixel.

Optionally, the first electrode layer 11 and the second electrode layer 12 are both in the array substrate 1.

Referring to FIG. 6, each of the plurality of branches 12B extends substantially throughout one dimension (e.g., the longitudinal dimension) of the second electrode layer 12. Any structure connecting the adjacent teeth or adjacent branches is disposed in peripheral regions of the second electrode layer 12. The first end E1 and the second end E2 of the first slit S1, and the third end E3 and the fourth end E4 of the second slit S2 are in peripheral regions of the second electrode layer 12.

In some embodiments, the second electrode layer 12 is a single domain electrode layer. In some embodiments, the second electrode layer 12 is a multi-domain electrode layer. Optionally, the second electrode layer 12 includes a first domain and a second domain, branches and slits in the first domain extending substantially along a first direction, and branches and slits in the second domain extending substantially along a second direction.

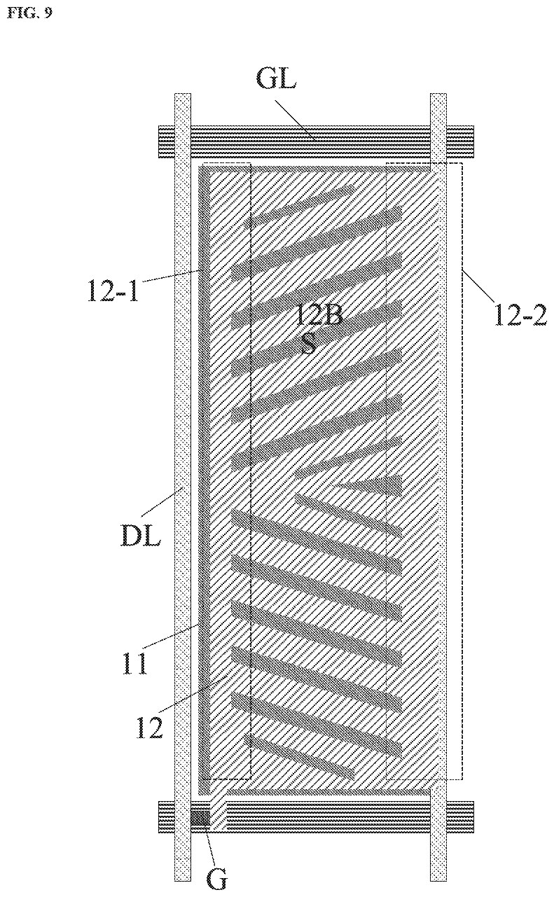

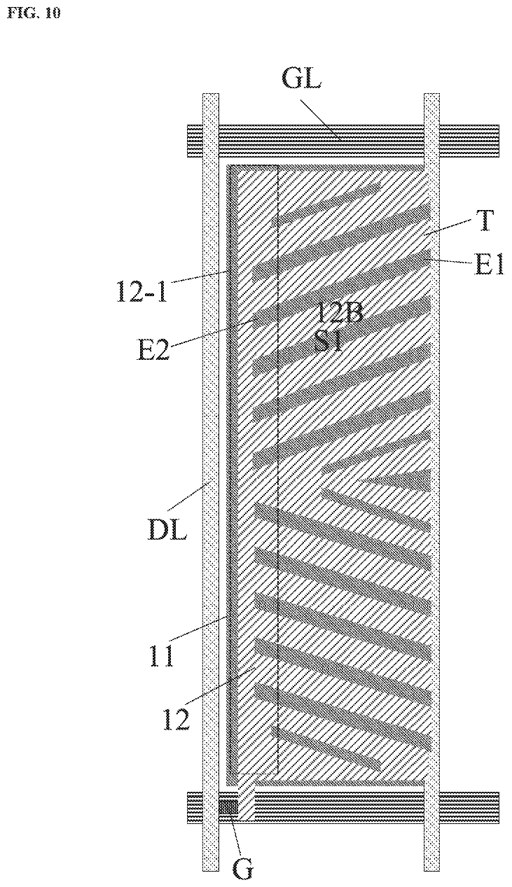

FIG. 9 is a schematic diagram illustrating the structure of a conventional liquid crystal display panel. Referring to FIG. 9, the conventional liquid crystal display panel in each subpixel includes a first electrode layer 11 and a second electrode layer 12. The second electrode layer 12 in some embodiments includes a first domain (the top domain) and a second domain (the bottom domain). The second electrode layer 12 includes a plurality of branches 12B spaced apart by a plurality of slits S. The plurality of branches 12B in the first domain extend substantially along a first direction. The plurality of branches 12B in the second domain extend substantially along a second direction. The plurality of branches 12B are connected together by a first bar 12-1 on the left side of the second electrode layer 12 and a second bar 12-2 on the right side of the second electrode layer 12. Each of the plurality of slits S has a first end and a second end, both of which are closed ends. For example, the first bar 12-1 and the second bar 12-2 close each of the plurality of slits S at its first end and the second end. The first electrode layer 11 extends to the edges of the subpixel. A projection of the first electrode layer 11 on the base substrate 10 overlaps with that of the first bar 12-1 of the second electrode layer 12 throughout the length of the first electrode layer 11 along the edge of the subpixel. Due to the large overlapping areas between the first electrode layer 11 and the second electrode layer 12, a large storage capacitance forms between the first electrode layer 11 and the second electrode layer 12, and light transmittance in the regions corresponding to the first bar 12-1 and the second bar 12-2 is reduced.

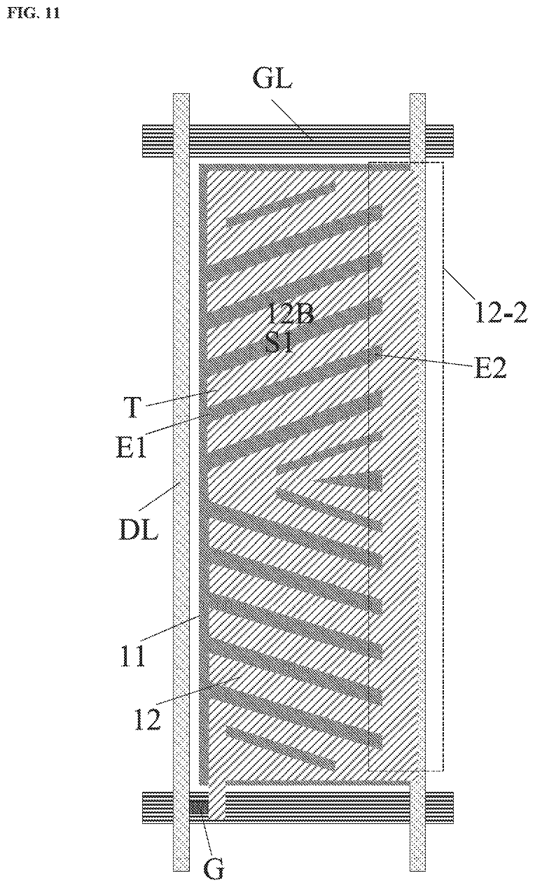

FIG. 10 is a schematic diagram illustrating the structure of a liquid crystal display panel in some embodiments according to the present disclosure. Referring to FIG. 10, the first electrode layer 11 (e.g., a common electrode layer) is a plate electrode layer that extends substantially throughout the subpixel area, e.g., extending to a first edge of the subpixel (e.g., a left longitudinal edge of the subpixel). The second electrode layer 12 includes a plurality of branches 12B, each of which extends substantially along a lateral direction of the subpixel. The plurality of branches 12B are spaced apart by a plurality of slits (e.g., a first slit S1 in FIG. 10). The plurality of branches 12B may be grouped into a plurality of teeth T. In the embodiment depicted in FIG. 10, each of the plurality of branches 12B corresponds to one of the plurality of teeth T, e.g., each of the plurality of teeth T includes only one of the plurality of branches 12B. Adjacent teeth of the plurality of teeth T are spaced apart by a first slit S1. Thus, in the embodiment depicted in FIG. 10, adjacent branches of the plurality of branches 12B are spaced apart by a first slit S1.

The first slit S1 is open at a first end E1 (e.g., the end proximal to a first signal line along a first edge of the subpixel), and closed at a second end E2 (e.g., the end proximal to a second signal line along a second edge of the subpixel, the second edge opposite to the first edge). The first end E1 is opposite to the second end E2. The first slit S1 extends along a direction substantially parallel to the adjacent teeth (or adjacent branches in an embodiment depicted in FIG. 10), the first end E1 of the first slit S1 proximal to a first end of one of the plurality of branches 12B and distal to a second end of the one of the plurality of branches 12B opposite to the first end of the one of the plurality of branches 12B; and the second end E2 of the first slit S1 proximal to the second end of one of the plurality of branches 12B and distal to the first end of the one of the plurality of branches 12B. The first slit S1 extends substantially throughout one dimension of the second electrode layer 12, e.g., throughout the lateral dimension of the second electrode layer 12. Adjacent teeth are separated from each other at the first end E1 and connected to each other at the second end E2. In the embodiments depicted in FIG. 10, adjacent branches of the plurality of branches 12B are separated from each other at the first end E1 and connected to each other at the second end E2.

The second electrode layer 12 depicted in FIG. 10 is a comb-shaped electrode layer having a plurality of teeth T and a bar (e.g., a first bar 12-1 as shown in FIG. 10) connecting the adjacent teeth of the plurality of teeth T at the second end E2. Each of the plurality of branches 12B extends substantially throughout one dimension (e.g., the lateral dimension) of the second electrode layer 12. Any structure connecting the adjacent teeth or adjacent branches is disposed in peripheral regions of the second electrode layer 12. The first end E1 and the second end E2 of the first slit S1 are in peripheral regions of the second electrode layer 12. The bar connecting the adjacent teeth of the plurality of teeth is also in a peripheral region of the second electrode layer 12.

FIG. 11 is a schematic diagram illustrating the structure of a liquid crystal display panel in some embodiments according to the present disclosure. In FIG. 11, the bar connecting the adjacent teeth or adjacent branches is a second bar 12-2 along an edge on the light side of the subpixel. Similar to the embodiment depicted in FIG. 10, the overlapping area and storage capacitance between the first electrode layer 11 and the second electrode layer 12 are significantly reduced as compared to conventional liquid crystal display panels. Light transmittance along the edges of the subpixels is enhanced, eliminating dark edges in image display.

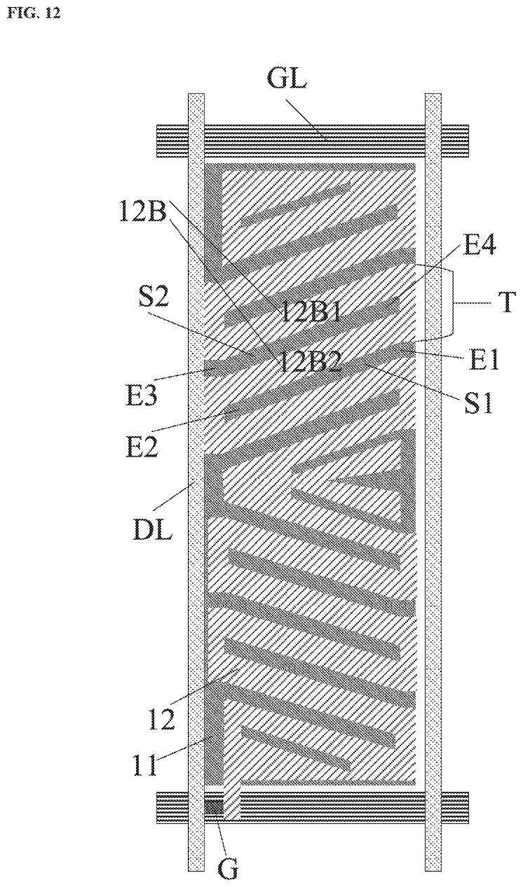

FIG. 12 is a schematic diagram illustrating the structure of a liquid crystal display panel in some embodiments according to the present disclosure. Referring to FIG. 12, the second electrode layer 12 includes a plurality of branches 12B (e.g., a first branch 12B1 and a second branch 12B2 in FIG. 12), each of which extends substantially along a lateral direction of the subpixel. The plurality of branches 12B are spaced apart by a plurality of slits (e.g., a first slit S1 and a second slit S2 in FIG. 12). The plurality of branches 12B are grouped into a plurality of teeth T, for example, in FIG. 12, each of the plurality of teeth T includes a first branch 12B1 and a second branch 12B2 of the plurality of branches 12B. The first branch 12B1 and the second branch 12B2 are connected to each other along the right edge of the subpixel. Adjacent teeth of the plurality of teeth T are spaced apart by a first slit S1. The first branch 12B1 and the second branch 12B2 in each of the plurality of teeth T are spaced apart by a second slit S2.

The first slit S1 is open at a first end E1 and closed at a second end E2, the first end E1 being opposite to the second end E2. The first slit S1 extends along a direction substantially parallel to the adjacent teeth or adjacent branches. The first slit S1 extends substantially throughout one dimension of the second electrode layer 12, e.g., throughout the lateral dimension of the second electrode layer 12. Adjacent teeth are separated from each other at the first end E1 and connected to each other at the second end E2. The second slit S2 is closed at a third end E3 and open at a fourth end E4, the third end E3 being opposite to the fourth end E4. The second slit S2 extends along a direction substantially parallel to the first branch 12B1 and the second branch 12B2 in each of the plurality of teeth T. The second slit S2 extends substantially throughout the one dimension of the second electrode layer 12, e.g., throughout the lateral dimension of the second electrode layer 12. In some embodiments, the second slit S2 is substantially parallel to the first slit S1. Optionally, the third end E3 is proximal to the first end E1 and distal to the second end E2, and the fourth end E4 is proximal to the second end E2 and distal to the first end E1. Optionally, the first branch 12B1 and the second branch 12B2 are separated from each other at the fourth end E4 and connected to each other at the third end E3. The second electrode layer 12 in FIG. 12 is a zig-zag shaped electrode layer. Along both the left edge and the right edge of the subpixel, the liquid crystal display panel includes a plurality of teeth T.

Referring to FIGS. 9 to 12, each of the plurality of branches 12B extends substantially throughout one dimension (e.g., the lateral dimension) of the second electrode layer 12. Any structure connecting the adjacent teeth or adjacent branches is disposed in peripheral regions of the second electrode layer 12. The first end E1 and the second end E2 of the first slit S1, and the third end E3 and the fourth end E4 of the second slit S2 are in peripheral regions of the second electrode layer 12.

In some embodiments, the liquid crystal display panel is a fringe field driven liquid crystal display panel, in which the liquid crystal layer is driven by a fringe electric field. Examples of fringe field driven liquid crystal display panel include, but are not limited to, an advanced super-dimensional switching (ADS) liquid crystal display panel, an in-plane switch (IPS) liquid crystal display panel, and a fringe field switching (FFS) liquid crystal display panel.

In another aspect, the present disclosure provides a liquid crystal display apparatus having a liquid crystal display panel described herein. Examples of appropriate display apparatuses include, but are not limited to, an electronic paper, a mobile phone, a tablet computer, a television, a monitor, a notebook computer, a digital album, a gaming system, etc.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. An array substrate having a plurality of subpixel areas, the array substrate in each of the plurality of subpixel areas comprising:
a first electrode layer and a second electrode layer configured to form a fringe field for driving liquid crystal molecules; and
an insulating layer between the first electrode layer and the second electrode layer;
wherein the second electrode layer comprises a plurality of branches;
the plurality of branches are grouped into a plurality of teeth;
adjacent teeth of the plurality of teeth are spaced apart by a first slit, the first slit extending substantially throughout one dimension of the second electrode layer of one of the plurality of subpixel areas; and
the adjacent teeth separated from each other at a first end and connected to each other at a second end.

2. The array substrate of claim 1, wherein each of the plurality of teeth comprises only one of the plurality of branches.

3. The array substrate of claim 2, wherein the second electrode layer is a comb-shaped electrode layer further comprising a bar connecting the adjacent teeth of the plurality of teeth at the second end.

4. The array substrate of claim 3, wherein the bar is in a peripheral region of the second electrode layer.

5. The array substrate of claim 4, further comprising a common electrode signal line;
wherein a projection of the common electrode signal line on the array substrate at least partially overlaps with that of the bar.

6. The array substrate of claim 5, wherein the projection of the common electrode signal line on the array substrate substantially overlaps with that of the bar.

7. The array substrate of claim 5, wherein the projection of the common electrode signal line on the array substrate completely covers that of the bar.

8. The array substrate of claim 4, further comprising a common electrode signal line;
wherein a projection of the common electrode signal line on the array substrate at least partially overlaps with those of the plurality of teeth at the first end.

9. The array substrate of claim 1, wherein each of the plurality of teeth comprises a first branch and a second branch of the plurality of branches; and
the first branch and the second branch are spaced apart by a second slit, the second slit extending substantially throughout the one dimension of the second electrode layer.

10. The array substrate of claim 9, wherein the second slit is substantially parallel to the first slit;
the first branch and the second branch are connected to each other at a third end and separated from each other at a fourth end;
the third end is proximal to the first end and distal to the second end; and
the fourth end is proximal to the second end and distal to the first end.

11. The array substrate of claim 9, wherein the second electrode layer is a zig-zag shaped electrode layer.

12. The array substrate of claim 1, wherein the first electrode layer is a plate electrode layer extending substantially throughout one of the plurality of subpixel areas.

13. The array substrate of claim 1, wherein each of the plurality of branches extends substantially throughout the one dimension of the second electrode layer.

14. The array substrate of claim 1, wherein any structure connecting the adjacent teeth is in peripheral regions of the second electrode layer.

15. The array substrate of claim 1, wherein the first end and the second end are in peripheral regions of the second electrode layer.

16. The array substrate of claim 1, wherein the second electrode layer comprises a first domain and a second domain, branches and slits in the first domain extending substantially along a first direction, and branches and slits in the second domain extending substantially along a second direction.

17. The array substrate of claim 1, wherein the plurality of branches extend substantially along a longitudinal direction of the subpixel area.

18. (canceled)

19. The array substrate of claim 1, wherein the first electrode layer is a common electrode layer, and the second electrode layer is a pixel electrode layer.

20. (canceled)

21. A liquid crystal display panel, comprising the array substrate of claim 1.

22. (canceled)

23. (canceled)

24. A liquid crystal display apparatus, comprising the liquid crystal display panel of claim 21.
